(19) United States
(12) Patent Application Publication
(10) Pub. No.: US 2024/0227707 A1
(43) Pub. Date: Jul. 11, 2024

(54) SYSTEM AND METHOD FOR DETECTING AND ALLEVIATING OCCUPANT DISCOMFORT

(71) Applicant: GM Global Technology Operations LLC, Detroit, MI (US)

(72) Inventors: Nilesh D. Mankame, Ann Arbor, MI (US); Dorel M. Sala, Troy, MI (US); Thomas A. Seder, Fraser, MI (US); Alok Warey, Novi, MI (US)

(21) Appl. No.: 18/150,359

(22) Filed: Jan. 5, 2023

(51) Int. Cl. B60R 16/037; B60H 1/00; B60N 2/02; B60W 10/30

(52) U.S. Cl. CPC B60R 16/037; B60H 1/00735; B60N 2/0248; B60W 10/30; G06V 20/59

(57) ABSTRACT

A system for detecting and alleviating occupant seat discomfort includes a plurality of vehicle systems, a plurality of sensors, a human machine interface (HMI) and a controller. The plurality of vehicle systems control the interior environment of the vehicle. The plurality of sensors sense the interior environment of the vehicle and a condition of the occupant. The HMI receives an occupant profile. The occupant profile includes characteristics of the occupant and a plurality of occupant preferences. The controller is programmed to execute a method to adjust at least one of the plurality of vehicle systems based on the determination that the occupant is in a discomfort state.

### INTRODUCTION

The present disclosure relates to vehicle interiors, and more particularly to vehicle systems to alleviate occupant discomfort.

To increase occupant comfort, vehicles are equipped with various interior systems, such as adjustable seats, heating, ventilating and air conditioning (HVAC) systems, interior lighting systems, and entertainment systems. Adjustable seats allow the occupant to adjust the seat configuration. For example, adjustable seats allow the occupant to bring the seat forward or backward, raise or lower the seat, recline the seat back and/or raise or lower the headrest. Additionally, the occupant may adjust seat temperature to further increase occupant comfort. Moreover, occupants may adjust the speed and temperature of the air in the interior of the vehicle by adjusting the HVAC system settings, including temperature, air distribution, and air flow rate. As well, the other vehicle interior systems may also be adjusted by the vehicle occupants to suit the occupants' comfort needs.

However, during periods of prolonged seating, occupants may experience discomfort. Occupants may experience poor blood circulation, or muscle fatigue in the neck, back, and lower torso. Current vehicle interior systems do not detect occupant discomfort and therefore, are unable to adjust the seat or other vehicle interior systems to alleviate the discomfort. Lack of discomfort detection and adjustment may leave the occupant in a state of discomfort for a prolonged period of time.

Thus, while current vehicle interior systems achieve their intended purpose, there is a need for a new and improved system and method for automatically adjusting the vehicle interior systems to alleviate occupant discomfort.

### SUMMARY

According to several aspects of the present disclosure, a system for alleviating discomfort of an occupant seated in a vehicle is disclosed. The system includes a plurality of vehicle systems for controlling an interior environment of the vehicle. Additionally, the system includes a plurality of sensors for sensing the interior environment of the vehicle and a condition of the occupant. Moreover, the system includes a controller in communication with the plurality of vehicle interior systems and the plurality of sensors. The controller is programmed to sense the interior environment of the vehicle to collect a first plurality of data inputs. Additionally, the controller is programmed to sense the condition of the occupant seated in the interior of the vehicle to collect a second plurality of data inputs. Moreover, the controller is programmed to determine whether the occupant is in one of a plurality of discomfort states based on the collected first and second plurality of data inputs. Lastly the controller is programmed to adjust at least one of the plurality of vehicle systems based on the determination that the occupant is in the discomfort state.

In an additional aspect of the present disclosure, the controller is programmed to determine one of a plurality of causes of the discomfort state of the occupant based on a subset of the first and second plurality of data inputs for each of a plurality of determined discomfort states.

In an additional aspect of the present disclosure, the controller is programmed to determine a probability that the one of the plurality of causes is based on a plurality of subsets of the first and second plurality of data inputs associated with each of a plurality of discomfort states.

In an additional aspect of the present disclosure, the controller is programmed to take a corrective action by adjusting one of the plurality of vehicle systems. The corrective action is based on at least one of the plurality of causes.

In an additional aspect of the present disclosure, the controller is programmed to intensify one of a plurality of corrective actions by a first multiplier and an another of a plurality of corrective actions by a second multiplier.

In an additional aspect of the present disclosure, the controller is programmed to select one of the first multiplier and the second multiplier based on a plurality of user preferences.

In an additional aspect of the present disclosure, the controller is programmed to adjust an adjustable seat system and an HVAC system based on determining the discomfort state.

In an additional aspect of the present disclosure, the controller is programmed to adjust the adjustable seat to a second seat configuration based on the determination that the type of discomfort is a second type of discomfort. The first seat configuration is different than the second seat configuration.

In an additional aspect of the present disclosure, the controller is programmed to capture an image or a sequence of images of the occupant after the corrective actions are taken.

In an additional aspect of the present disclosure, the controller is programmed to determine the effectiveness of the corrective actions based on an analysis of the above image or sequence of images.

According to several aspects of the present disclosure, a method for alleviating seat discomfort of an occupant seated in a vehicle is disclosed. The method includes providing a plurality of vehicle systems for controlling an interior environment of the vehicle. Additionally, the method includes providing a plurality of sensors for sensing the interior environment of the vehicle and a condition of the occupant. Moreover, the method includes providing a controller in communication with the plurality of vehicle interior systems and the plurality of sensors. Additionally, the method includes sensing the interior environment of the vehicle to collect a first plurality of data inputs. Moreover, the method includes sensing the condition of the occupant seated in the interior of the vehicle to collect a second plurality of data inputs. Additionally, the method includes determining whether the occupant is in one of a plurality of discomfort states based on the collected first and second plurality of data inputs. Lastly the method includes adjusting at least one of the plurality of vehicle systems based on the determination that the occupant is in the discomfort state.

In an additional aspect of the present disclosure, the method includes determining one of a plurality of causes of the discomfort state of the occupant based on a subset of the first and second plurality of data inputs for each of a plurality of determined discomfort states.

In an additional aspect of the present disclosure, the method includes determining a probability that the one of the plurality of causes is based on a plurality of subsets of the first and second plurality of data inputs associated with each of a plurality of discomfort states.

In an additional aspect of the present disclosure, the method includes taking a corrective action by adjusting one of the plurality of vehicle systems, wherein the corrective action is based on at least one of the plurality of causes.

In an additional aspect of the present disclosure, the method includes intensifying one of a plurality of corrective actions by a first multiplier and an another of a plurality of corrective actions by a second multiplier. The first multiplier is less than the second multiplier.

In an additional aspect of the present disclosure, the method includes selecting one of the first multiplier and the second multiplier based on a plurality of user preferences.

In an additional aspect of the present disclosure, the method includes adjusting an adjustable seat system and an HVAC system based on determining the discomfort state.

In an additional aspect of the present disclosure, the method includes adjusting the adjustable seat to a second seat configuration or adjusting some other controllable attribute that influences the vehicle interior environment based on the determination that the type of discomfort is a second type of discomfort. The first seat configuration is different than the second seat configuration and/or the first vehicle interior attribute setting is different from the second vehicle interior attribute setting.

In an additional aspect of the present disclosure, the method includes capturing an image or a sequence of images of the occupant after the corrective actions are taken.

In an additional aspect of the present disclosure, the method includes determining the effectiveness of the corrective actions by analyzing the above sequence of images.

### BRIEF DESCRIPTION OF THE DRAWINGS

The drawings described herein are for illustration purposes only and are not intended to limit the scope of the present disclosure in any way.

FIG. 1 is a schematic diagram of a system for detecting and alleviating the discomfort of an occupant seated in an adjustable seat in a vehicle, according to an exemplary embodiment of the present disclosure;

FIG. 2 is a diagram of a method for detecting and alleviating the discomfort of an occupant seated in an adjustable seat in a vehicle, according to an exemplary embodiment of the present disclosure;

FIG. 3 is a diagram of a method for identifying a plurality of discomfort states based on a plurality of inputs (input vector), according to an exemplary embodiment of the present disclosure;

FIG. 4 is a diagram of a method for identifying a plurality of underlying causes based on a plurality of discomfort states, according to an exemplary embodiment of the present disclosure; and

FIG. 5 is a diagram of a method of identifying a plurality of corrective actions base on a plurality of underlying causes, according to an exemplary embodiment of the present disclosure.

### DETAILED DESCRIPTION

The following description is merely exemplary in nature and is not intended to limit the present disclosure, application, or uses.

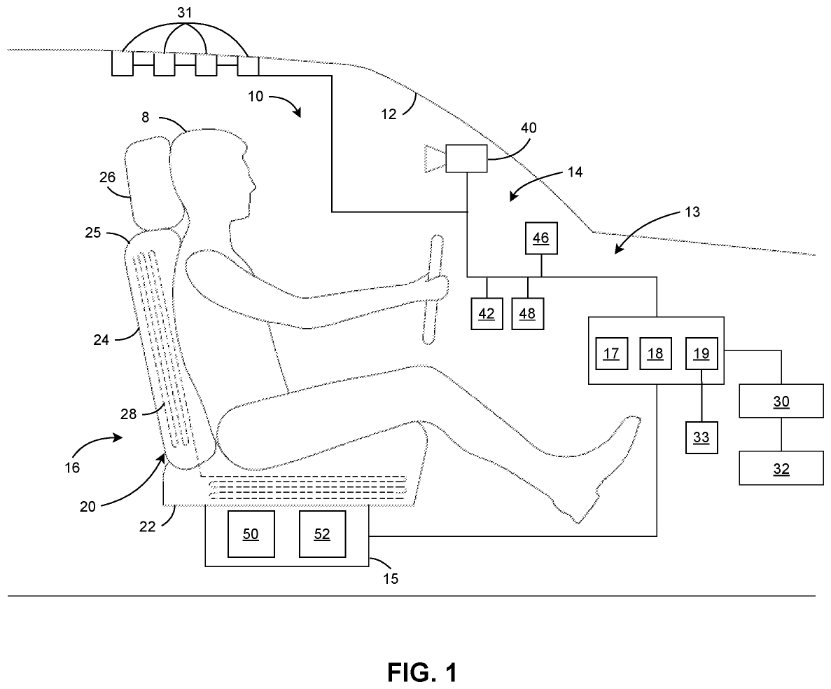

Referring to FIG. 1, a schematic diagram of a system 10 for detecting and alleviating the discomfort of an occupant 8 seated in an interior of a vehicle 12 is illustrated. The system 10 is arranged within an interior of the vehicle 12, and generally includes a plurality of vehicle systems 13, a plurality of sensors 14, and a controller 15. System 10 is configured to detect whether the occupant 8 is in a state of discomfort while seated in the interior of the vehicle 12. It should be appreciated that vehicle 12 may be any type of vehicle having a occupant compartment having seating for a driver of the vehicle and one or more passengers or may be an autonomous or self-driving vehicle having no driver per se, in accordance with the scope of the present disclosure.

The plurality of vehicle systems 13 include, for example, an adjustable seat system 16, a heating, ventilating and air conditioning (HVAC) system 17, an ambient lighting system 18 and an entertainment system 19. The adjustable seat system 16 includes one or more adjustable seats 20. The adjustable seat 20 is configured to support the occupant 8 in a seated position in an interior of the vehicle 12. The adjustable seat 20 may be a driver seat or one or more occupant seats. In one embodiment the adjustable seat 20 has a seat bottom 22, a seat back 24, and a headrest 26. The seat bottom 22 may be positioned horizontally both forward and back in vehicle 12, as well as vertically relative to a floor of the vehicle. The seat back 24 is pivotably attached to and rotatable about the rear of the seat bottom 22. For example, the seat back 24 may be rotated and fixed at an angle to support the occupant 8 at a desired incline or angle. The headrest 26 is attached in line with the topmost portion 25 of the seat back 24 and can be extended vertically and/or rotated angularly to a fixed angle. The adjustable seat 14 may also include a seat climate control system 28 contained within the seat bottom 22 and seat back 24 to heat or cool the adjustable seat 20. It should be appreciated that the adjustable seat 20 may contain other components in accordance with the scope of the present disclosure, such as a lumbar support system (not shown), side bolsters (not shown), an inflatable seat bladder (not shown), side arm rests (not shown), or a calf support system (not shown), all of which may also be adjusted or repositioned. The adjustable seat 20 may be adjusted to a desired configuration to prevent occupant discomfort. For example, a particular adjustable seat 20 configuration in the context of the present disclosure may be to raise the seat bottom 22 or change the angle of the seat back 24.

The heating, ventilating and air conditioning (HVAC) system 17 is configured to provide conditioned air to the occupant compartment of vehicle 12. As an example, the HVAC system 17 includes a blower, a heat exchanger, evaporator, ducts, and louvered vents. The blower pushes air through a heat exchanger and/or evaporator to provide conditioned air to the occupant compartment. The conditioned air passes through the ducts and exits from louvered vents positioned within the vehicle 12 that allow the occupant 8 of the vehicle 12 to direct the flow of the conditioned air. HVAC system 17 includes a series of HVAC user interface (UI) controls 30 that allow the vehicle occupants 8 adjust the operation of the HVAC system, for example, raise or lower the temperature of the conditioned air and/or increase or decrease the blower speed to increase or decrease air flow within the vehicle 12. Moreover, HVAC system 17 may include one or more zones that may be individually adjusted according to the desires of one or more vehicle occupants.

The ambient lighting system 18 is provided in the interior occupant compartment of the vehicle 12. The ambient lighting system 18 illuminates the interior of the vehicle 12 which allows the occupant 8 to perceive the interior of the vehicle 12. Ambient lighting system 18 includes a plurality of light fixtures 31. Light fixtures 31 may be mounted at various locations on the interior surfaces of the occupant compartment of the vehicle 12. For example, light fixtures 31 may be mounted in the headliner, the instrument panel, interior door panels and trim panels and other occupant compartment locations. Light fixtures 31 may be comprised of incandescent bulbs or light-emitting diodes (LEDS) that are dimmable.

An entertainment system 19 is provided in the interior of vehicle 12 to provide sound in the form of music or the like to the vehicle occupants. Entertainment system 19 generally includes a radio receiver and a plurality of speakers 32. The radio receiver receives radio signals that are converted by the radio receiver to audible sound to be broadcasted throughout the occupant compartment by the plurality of speakers 32. The plurality of speakers 32 may be placed at various locations within the occupant compartment to provide the vehicle occupants 8 with stereo or surround sound or the like. The radio signals may be digital or analogue, and may be broadcasted by multiple sources including radio stations and internet content providers.

A human machine interface (HMI) 33 is connected to the controller 15 to provide a way for the vehicle occupants 8 to control the vehicle systems 13 and input information into the system 10 including channel selection, volume control, speaker settings and more. Moreover, the HMI 33 may also receive user profile information. Some aspects of the user profile are input data (e.g. height, weight, age). Other aspects of the profile are explicit user preferences (e.g. tolerate cold better than heat, sensitive to bright lights, etc). The explicit user preferences are combined with the implicit user preferences that are learned by the system 10 after a period of use. The complete set of user preferences influences the method 100 described below in determining the state of discomfort of an occupant to perform at least one corrective action.

The plurality of sensors 14 are disposed within the interior of the occupant compartment to collect data regarding the condition of the vehicle occupants 8 and the condition of the occupant compartment of the vehicle 12. The plurality of vehicle sensors 14 may include, for example, a camera 40, temperature sensor 42, light sensor 46 and sound sensor or microphone 48. For example, the camera 18 is positioned to view the occupant 8 seated in the adjustable seat 20 and has a full and unobstructed view of the occupant 8. The camera 40 is a photo and/or video camera used to capture inputs 200. It should be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure. Moreover, the present disclosure contemplates that camera 40 may be comprised of a plurality of cameras. For example, one camera is configured to capture a visible part of the electro-magnetic spectrum, another camera is configured to capture the infrared (IR) part of the spectrum, and yet another camera is configured to capture the ultraviolet (UV) part of the spectrum. Alternatively, one camera is configured to capture all the relevant parts IR, visible and UV portions of the spectrum.

The temperature sensor 42 is mounted in the occupant compartment and is configured to sense the temperature of the interior of the vehicle 12. The camera 40 configured as an infrared camera senses the temperature of the occupants 8 of the vehicle 12, including, for example, the temperature of the face and hands of the occupants 8. The light sensor 46 is mounted in the occupant compartment and is configured to sense the ambient light of the interior of the vehicle 12. Additionally, light sensors may be mounted on the exterior of the vehicle 12 to sense the light level outside the vehicle 12. The sound sensor or microphone 48 is also mounted in the interior of the vehicle 12, for example, in the instrument panel. The sound sensor 48 is configured to sense and receive audible sounds in the occupant compartment.

The controller 15 is in electrical communication with the plurality of vehicle systems 13 and the plurality of sensors 14. Accordingly, the controller 15 receives information or data from the plurality of sensors 14 and adjusts or controls the operation of the plurality of vehicle systems 13. Controller 15 includes at least one processor 50 and a non-transitory computer readable storage device or media 52. The processors 50 may be a custom made or commercially available processor, a central processing unit (CPU), a graphics processing unit (GPU), an auxiliary processor among several processors associated with the controller 15, a semiconductor-based microprocessor (in the form of a microchip or chip set), a macroprocessor, a combination thereof, or generally a device for executing instructions. The computer readable storage device or media 52 may include volatile and nonvolatile storage in read-only memory (ROM), random-access memory (RAM), and keep-alive memory (KAM), for example. KAM is a persistent or non-volatile memory that may be used to store various operating variables while the processor 50 is powered down. The computer-readable storage device or media 52 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 15 to control the vehicle systems 13. The controller 15 may also consist of multiple controllers which are in electrical communication with each other and, for example, include dedicated system controllers that individually and independently and at the direction of controller 15 control the operation of the vehicle systems 13. It should be understood that various additional wired and wireless techniques and communication protocols for communicating with the controller 15 are within the scope of the present disclosure.

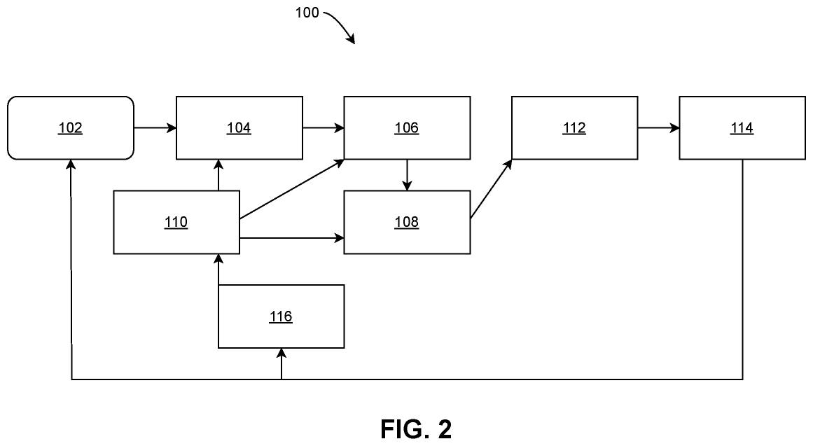

Referring now to FIG. 2, a method 100 for detecting and alleviating occupant discomfort is illustrated as a block diagram. The method 100 for example is stored as executable code in memory of controller 15. The controller 15 is configured to execute the executable code to carry out method 100. The method 100 starts at block 102. At block 102, a plurality of inputs 200 or data are received by the controller 15, the vehicle systems 13, and the plurality of sensors 14. The plurality of inputs 200 may be categorized by vehicle system that the inputs 200 pertain to, for example the adjustable seat system 16, HVAC system 17, lighting system 18, and entertainment system 19. Accordingly, the adjustable seat system 16 includes the following data inputs: seat bottom angle, seatback angle, fore/aft seat position, headrest height, headrest fore/aft position, calf support angle and the like. The HVAC system 17 includes the following data inputs: air inlet temperature, air outlet temperature, seat heater level, seat heater on-time, ambient air temperature, season, occupant compartment relative humidity. The lighting system 18 includes the following data inputs: light intensity of the interior occupant compartment, light intensity of the exterior of the occupant compartment, indication of daytime, indication of nighttime. The entertainment system 19 includes the following data inputs: sound volume, channel selection and the like. There are data inputs related to the occupant 8 as well these data inputs include, for example: height, weight, gender, hip angle, knee angle, neck angle, ankle angle, elbow angle, and the like. The inputs described above may be determined through communication with the vehicle systems 13 and using the plurality of sensors 14. Additionally, vehicle occupants 8 may input personal characteristics such as height, weight, gender, and the like into the HMI 33 as described above.

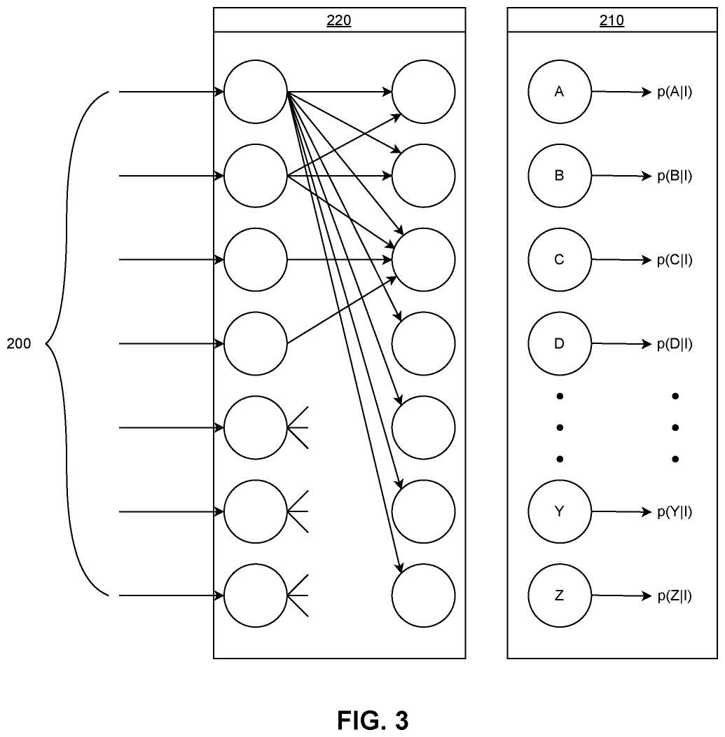

At block 104, the method 100 determines the discomfort state 210 that the vehicle occupant may be experiencing based on an input vector 200 comprised of a set of inputs including an instantaneous occupant posture or a timed history of occupant postures as well as various environmental conditions. The occupant posture is the current position of the occupant 8 in the vehicle 12 including occupant adjustments to a seated position. Occupant position may include, but is not limited to, the occupant neck angle over a duration of time, the occupant back (or torso) angle, occupant hip angle and position over a duration of time, and knee angle of the occupant 8. Environmental conditions include, but are not limited to, temperature of the occupant compartment, air flow rate from the HVAC system 17, ambient light level, and ambient noise level of the vehicle 12. Seat configuration includes the seat pan angle, the back rest angle, headrest angle and height. As shown in FIG. 3, the input vector 200 is mapped to one or more discomfort states 210 through the use of a mathematical model. Examples of suitable mathematical models include neural networks (NN) 220, regression models, decision trees, and Markov chain models. In one embodiment of the present disclosure, the neural network 220 is trained through data collected through trials at customer clinics, and information obtained from literature or through commercial data sources. For example, a population of customers are invited to attend a customer clinic where the customers are asked to sit in a vehicle occupant compartment for an extended period of time. The various vehicle systems 13 are activated to provide the desired level of comfort to the occupant 8 or customer. The discomfort states 210 is recorded for each occupant for a given subset of the inputs 200 described above. For example, a given input vector includes a subset of inputs 200 which may include the seat back angle, seat pan angle over a duration of time, headrest height, head rest fore-aft location over a duration of time, height of occupant, and weight of occupant. If the occupant complains of neck pain, then the discomfort state 210 for the given subset of inputs 200 is neck pain. Other discomfort states 210 may include back pain, fatigue, overheating, arm pain, etc. The discomfort states 210 are labeled A through Z in FIG. 3.

The discomfort states 210 of FIG. 3 are determined through the use of mapping input vector 200 to discomfort states 210 developed using the data collected at the customer clinics. The mapping of input vector 200 to discomfort states 210 provides an output expressed as p(A|\vec{I}), where p is the probability that A is the discomfort state resulting from the input vector \vec{I} containing a particular set of inputs 200. A mapping is developed for each of the discomfort states A through Z. A given \vec{I} might trigger one or more discomfort states (e.g. a seat that is positioned too far away from the steering wheel for the occupant's height and anthropometric measurements might lead to fatigue in the arms as well as pain in the elbows and neck).

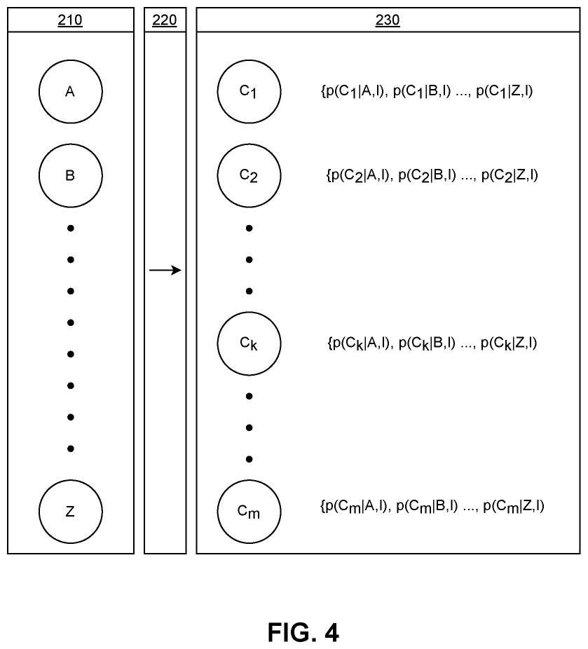

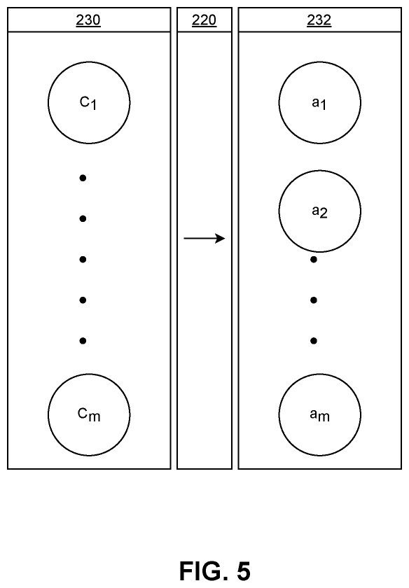

With continuing reference to FIG. 2, after the discomfort states 210 are determined at block 104, the underlying causes 230 (shown in FIGS. 4 and 5) for the occupant discomfort are identified at block 106. As shown in FIG. 4, NN 220 is employed to map the discomfort states 210 to one or more underlying causes 230 for each of the discomfort states 210. Again, the mapping of the discomfort states 210 to one or more underlying causes 230 is developed through the use of data collected at customer clinics, information gathered from the literature and from commercial data sources and are used to associate the discomfort states 210 with one or more underlying causes 230. The underlying causes 230 are shown in FIG. 4 and referenced as C₁ through Cₘ. For each underlying cause Ci the mapping yields a vector of probabilities that the underlying cause Cᵢ cause is the reason for each of the discomfort states A through Z. This vector may be expressed as {p(C₁/A, \vec{I}), p(C₁/B, \vec{I}) . . . p(C₁/Z, \vec{I})} for the underlying cause C₁, where p(C₁/A, \vec{I}) represents the likelihood that C₁ is an underlying cause if A has been identified as the discomfort state for an input vector \vec{I}.

Returning to FIG. 2, after the underlying causes 230 are determined at block 106, method 100 moves to block 108 to determine the corrective actions to take. The corrective actions 232 are further shown in FIG. 5. The underlying causes 230 are mapped to corrective actions 232 where each corrective action is referenced as a₁ to aₙ in FIG. 5. For a given underlying cause C₁ to Cₙ, the corrective actions taken may consist of one or more corrective actions 232, for example a₁ to aₙ. The mapping from underlying causes to corrective actions, which includes the selection of one or more corrective actions and the respective intensities, is influenced by the user preferences, as illustrated by block 110 of FIG. 2, that are entered into the HMI 33. Accordingly, the corrective actions 232 taken by method 100 may be differently weighted such that one particular corrective action is performed at a higher level or intensity than another corrective action. After block 108, method 100 moves to block 112.

At block 112 of FIG. 2, method 100 implements the corrective actions 232 identified at block 108. Changes are made to the vehicle systems 13 to alleviate the discomfort state 210 identified at block 104. For example, changes may be made to the HVAC system if the discomfort state is that the occupant 8 is sweating. More specifically, method 100 would instruct the HVAC system 17 to lower the temperature of the occupant compartment. Moreover, if the discomfort state 210 is neck pain then the method 100 would instruct the adjustable seat system 16 to raise the headrest 26, reduce the inclination of the seat back 24, or move the seat closer to the steering wheel for example. After block 112, method 100 moves to block 114.

At block 114, the method 100 observes the occupant 8 and collects the input data using the plurality of sensors 14 to determine whether the occupant 8 is presently in a discomfort state 210 or if the changes implemented at block 112 have alleviated the discomfort. At block 114, the camera 40 captures an input vector 200 with time stamps of the occupant 8 in the adjustable seat 20. The input vector 200 are used to determine the posture of the occupant 8, for example, is the occupant 8 leaning forward in the seat or is the occupant 8 rising out of the seat, as well, as the various input vectors 200 described above related to the occupant 8. After block 114, the method 100 moves simultaneously to block 102, where the whole loop repeats, and block 116 where an assessment is made of the effectiveness of the changes made to the vehicle systems 13, at block 112. The inferred effectiveness is used to update the set of explicit and implicit user preferences in block 110, which in turn influences all of the mappings discussed earlier beginning with the next iteration of the loop.

For example, a first type of discomfort state 210 is inferred when one or more of the input vectors 200 show the occupant 8 rising partially from the adjustable seat 20 and repositioning themselves before returning to the adjustable seat 20, which indicates muscle fatigue in the upper thigh and sitting bone (ischial tuberosities) regions of the occupant 8. Alternatively, a second type of discomfort state 210 may be inferred when one or more of the input vectors 200 show the occupant 8 leaning forward without rising from the adjustable seat 20 and pushing themselves forward or rearward, which indicates muscle fatigue in the pelvis and lumbar region of the occupant 8. Alternatively, a third type of discomfort state 210 may be inferred when one or more of the input vectors 200 show the occupant 8 flexing their neck laterally or vertically, which indicates muscle fatigue in the neck and upper torso of the occupant 8. Alternatively, a fourth type of discomfort state 210 may be inferred when one or more of the input vectors 200 show the occupant extending their legs to reach a pedal during braking or acceleration, which indicates over extension of a knee and ankle of the occupant 8. Finally, a fifth type of discomfort state 210 may be inferred when one or more of the input vectors 200 show the occupant 8 does not change posture over a prescribed time duration, which is predictive of poor blood circulation in the occupant's 8 limbs. It should be appreciated that the above list of types of occupant discomfort is non-exhaustive, and that various other types of occupant discomfort are within the scope of the present disclosure.

In an exemplary embodiment, the method 100 adjusts the adjustable seat 20 using the controller 15 based on the determination of the type of discomfort state 210 associated with the one or more of the input vectors 200 or data received by the plurality of sensors 14. For example, the controller 15 will adjust the angle of the seat pan 22 (i.e., a first seat configuration), if a determination is made that occupant 8 is in the first type of discomfort state 210, as described above. However, the present disclosure contemplates other adjustments to adjustable seat 20 or the other vehicle systems 13 may be made for a particular discomfort state. Alternatively, the controller 15 will adjust the angle of the seat back 24 (i.e., a second seat configuration), if a determination is made that occupant 8 is in the second type of discomfort state 210, as described above. Alternatively, the controller 15 will adjust the position of the head rest 26 (i.e., a third seat configuration), if a determination is made that occupant 8 is in a third type of discomfort state 210, as described above. Alternatively, the controller 15 will adjust the angle of the seat bottom 22 or adjust the angle of the seat back 24 (i.e., a fourth seat configuration), if a determination is made that occupant 8 is in a fourth type of discomfort state 210, as described above. Finally, the controller 15 will adjust the angle of the seat bottom 22 or the angle of the seat back 24 (i.e., a fifth seat configuration), if a determination is made that occupant 8 is in a fifth type of discomfort state, as described above. Thus, the seat adjustment or configuration selected by the controller 15 is based on the determination of the type of discomfort state 210. It should be appreciated that the above list of types of seat adjustments or seat configurations are non-exhaustive, and that various other potential corrective actions and combinations of corrective actions 232 to alleviate occupant discomfort are within the scope of the present disclosure.

It should also be noted that in some embodiments the method 100, will wait a predefined time period after the seat configuration of the adjustable seat 20 is changed before making a subsequent change in the configuration of the adjustable seat 20. The predefined time period is the period of time that the method 100 will wait before making another adjustment to the adjustable seat 20, for example, the predefined time period could be between 5 and 30 minutes.

It should also be appreciated, that the method 100 has filtering capability to distinguish when the occupant 8 is adjusting miscellaneous vehicle controls versus presenting a posture indicative of discomfort. The mathematical model of method 100 will learn and store input vectors 200 or movements depicting the occupant 8 adjusting an in-vehicle entertainment system 19 or the HVAC UI controls 30 and associate these input vectors 200 with an occupant 8 that is not in a discomfort state (i.e., that no seat 20 adjustment is needed).

The system and method for detecting and alleviating occupant discomfort of the present disclosure offers several benefits and advantages. For example, the performance of the system can continuously improve by learning through assessing the effectiveness of any corrective actions and updating the implicit preferences of the occupant accordingly. The method 100 is applicable to all vehicle environments and can be applied to different vehicles. Advantageously, adjustments made to or changes to the configuration of the adjustable seat 20 may prevent occupants 8 from experiencing poor blood circulation or muscle fatigue in the neck, back, and lower torso caused by prolonged or improper seating postures. Therefore, by utilizing the method 100 of the present disclosure to recognize and alleviate occupant discomfort, long term driving performance can be maximized, thereby improving occupant comfort and maneuverability.

Moreover, it should be appreciated that various alternatives for detecting occupant 8 movement in the adjustable seat 20 are within the scope of the present disclosure, such as pressure mapping of the adjustable seat 20 or gathering additional input vectors 200 from wearables (i.e., a smart watch or smart ring) interfaced with a BCM (body control module) or MSM (Memory Seat Module).

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A system for alleviating discomfort of an occupant seated in a vehicle, the system comprising:
a plurality of vehicle systems for controlling an interior environment of the vehicle;
a plurality of sensors for sensing the interior environment of the vehicle and a condition of the occupant;
a human machine interface (HMI) for receiving an occupant profile, wherein the occupant profile includes characteristics of the occupant and a plurality of occupant preferences; and
a controller in communication with the plurality of vehicle interior systems, the plurality of sensors and the HMI and, wherein the controller is programmed to:
sense the interior environment of the vehicle to collect a first plurality of data inputs;
sense the condition of the occupant seated in the interior of the vehicle to collect a second plurality of data inputs;
receive a third plurality of data inputs, wherein the third plurality of data inputs includes the occupant profile;
determine whether the occupant is in at least one of a plurality of discomfort states based on the collected first, second and third plurality of data inputs; and
adjust at least one of the plurality of vehicle systems based on the determination that the occupant is in the at least one of a plurality of discomfort states.

2. The system of claim 1, wherein the controller is further programmed to determine at least one of a plurality of causes of the at least one of a plurality of discomfort states of the occupant based on a subset of the first, second and third plurality of data inputs for each of the at least one of a plurality of discomfort states.

3. The system of claim 2, wherein the controller is programmed to determine at least one of a plurality of causes of the at least one of the plurality of discomfort state of the occupant further comprises determine a probability that the one of the plurality of causes is based on a plurality of subsets of the first, second and third plurality of data inputs associated with each of a plurality of discomfort states.

4. The system of claim 3, wherein the controller is programmed to adjust at least one of the plurality of vehicle systems based on the determination that the occupant is in the at least one of the plurality of discomfort states further includes perform at least one corrective action by adjusting one of the plurality of vehicle systems, wherein the at least one corrective action is based on at least one of the plurality of causes.

5. The system of claim 1, wherein the controller is programmed to perform at least one corrective action by adjusting one of the plurality of vehicle systems further includes apply a weighting to the at least one corrective action.

6. The system of claim 5, wherein the controller is programmed to apply a weighting to the at least one corrective action further includes apply a weighting to the at least one corrective action based on the third plurality of data inputs.

7. The system of claim 5, wherein the controller is programmed to perform at least one corrective action by adjusting one of the plurality of vehicle systems further includes adjust an adjustable seat system and an HVAC system based on determining the at least one of the plurality of discomfort states.

8. The system of claim 7, wherein the controller is programmed to adjust at least one of the plurality of vehicle systems based on the determination that the occupant is in the discomfort state further includes adjust the at least one of the plurality of vehicle systems from a first setting to a second setting based on the determination that the type of discomfort is a second type of discomfort, wherein the second setting is different from the first setting.

9. The system of claim 8, wherein the controller is further programmed to capture at least one image of the occupant after the at least one corrective action is taken.

10. The system of claim 9, wherein the controller is further programmed to determine the effectiveness of the at least one corrective action based on an analysis of the image.

11. A method for alleviating seat discomfort of an occupant seated in a vehicle, the method comprising:
providing a plurality of vehicle systems for controlling an interior environment of the vehicle;
providing a plurality of sensors for sensing the interior environment of the vehicle and a condition of the occupant;
providing a human machine interface (HMI) for receiving an occupant profile, wherein the occupant profile includes characteristics of the occupant and a plurality of occupant preferences;
providing a controller in communication with the plurality of vehicle interior systems, the plurality of sensors and the HMI;
sensing the interior environment of the vehicle to collect a first plurality of data inputs;
sensing the condition of the occupant seated in the interior of the vehicle to collect a second plurality of data inputs;
receiving a third plurality of data inputs, wherein the third plurality of data inputs includes the occupant profile;
determining whether the occupant is in at least one of a plurality of discomfort states based on the collected first and second plurality of data inputs; and
adjusting at least one of the plurality of vehicle systems based on the determination that the occupant is in the at least one of a plurality of discomfort states.

12. The method of claim 11, further comprising determining at least one of a plurality of causes of the discomfort state of the occupant based on a subset of the first, second and third plurality of data inputs for each of a plurality of determined discomfort states.

13. The method of claim 12, wherein determining at least one of a plurality of causes of the at least one of the plurality of discomfort states of the occupant further comprises determine a probability that the one of the plurality of causes is based on a plurality of subsets of the first, second and third plurality of data inputs associated with each of a plurality of discomfort states.

14. The method of claim 13, wherein adjusting at least one of the plurality of vehicle systems based on the determination that the occupant is in the at least one of the plurality of discomfort states further includes perform at least one corrective action by adjusting one of the plurality of vehicle systems, wherein the at least one corrective action is based on at least one of the plurality of causes.

15. The method of claim 11, wherein performing at least one corrective action by adjusting one of the plurality of vehicle systems further includes applying a weighting to the at least one corrective action.

16. The method of claim 15, wherein applying a weighting to the at least one corrective action further includes apply a weighting to the at least one corrective action based on the third plurality of data inputs.

17. The method of claim 16, wherein performing at least one corrective action by adjusting one of the plurality of vehicle systems further includes adjusting an adjustable seat system and an HVAC system based on determining the at least one of the plurality of discomfort states.

18. The method of claim 17, wherein adjusting at least one of the plurality of vehicle systems based on the determination that the occupant is in the discomfort state further includes adjusting the at least one of the plurality of vehicle systems from a first setting to a second setting based on the determination that the type of discomfort is a second type of discomfort, wherein the second setting is different from the first setting.

19. The method of claim 18, further comprising capturing at least one image of the occupant after the at least one corrective action is taken.

20. The method of claim 18, further comprising determining the effectiveness of the at least one corrective action based on an analysis of the image.
